(19) United States
(12) Patent Application Publication
(10) Pub. No.: US 2008/0259853 A1
(43) Pub. Date: Oct. 23, 2008

(54) Radio Lan System, and Base Station and Terminal Station Thereof

(75) Inventor: Yoichi Ito, Saitama (JP)

Correspondence Address: FOLEY AND LARDNER LLP;SUITE 500, 3000 K STREET NW, WASHINGTON, DC, 20007, US

(73) Assignee: PIONEER CORPORATION

(21) Appl. No.: 11/909,916

(22) PCT Filed: Mar. 27, 2006
(86) PCT No.: PCT/JP2006/306189

§ 371 Date: Nov. 13, 2007

(30) Foreign Application Priority Data
Mar. 31, 2005 (JP) 2005-104272

(51) Int. Cl. H04Q 7/00

(52) U.S. Cl. 370/329

(57) ABSTRACT

A wireless LAN system that includes a plurality of stations and an access point, interconnected via a network, and supports QoS has infrastructure mode and a Direct Link. In the infrastructure mode, data communication is performed between stations STA via an access point AP. In the Direct Link, data communication is performed directly between the stations STA. The access point AP performs a process for reserving a bandwidth 2W that is twice a bandwidth W required when the Direct Link is used, in response to a QoS bandwidth reservation request when the Direct Link is used from a station STA. As a result, the QoS of data transfer can be ensured even when the Direct Link is terminated.

### TECHNICAL FIELD

The present invention generally relates to a wireless LAN system and stations and an access point used in the wireless LAN system. The present invention more particularly relates to a wireless LAN system compatible with QoS and including a plurality of stations and an access point that are connected to each other via a network, and relates to stations and an access point for use in the wireless LAN system.

### BACKGROUND ART

In computer networks, packet transmission and reception are carried out using a communication system called a packet communication system. Recently, demand for establishing a network using wireless communication is increasing in a household LAN (Local Area Network), for example. As compared with a wired LAN, the wireless LAN has such advantages that the installation of a wire such as a cable is not necessary and that the degree of freedom of moving a terminal connected to the LAN is high.

The IEEE802.11 radio communication system (a system based on the ANSI/IEEE Std 802.11, 1999 Edition) is available as a standard wireless LAN. The IEEE802.11 standard has been further divided into according to frequency bands and communication speeds used.

In the network such as the wireless LAN, when performing transmission or reception of packets, the communication devices connected to the network share one network route in time sharing manner. The efficiency of band utilization effected greatly depending on managing methods of transmission right.

For example, when carrying out transmission and reception of motion data, such as video data, in streaming via the wireless LAN, unless the transmission right is managed accurately, there is a possibility of occurrence of frame dropping, fuzzy images, and voice interruption at the reception side. Accordingly, the IEEE802.11e is proposed as the standard which takes QoS (Quality Of Service) into consideration (see, for example, Nonpatent Literature 1).

FIG. 15 are diagrams explaining a QoS data transfer based on IEEE802.11e. FIG. 15-1 is a diagram of a configuration of a wireless LAN system complying with IEEE802.11e. FIG. 15-2 is a diagram of an example of a QoS data transfer sequence based on IEEE802.11e. In FIG. 15, based on IEEE802.11e, when a station (STA) 501 transmits a parameter, such as a required bandwidth, to an access point (AP) 500, the AP 500 grants a transmission right to the STA 501 through polling and performs non-competitive data transfer. As a result, a data transfer of which the QoS is ensured can be performed.

FIG. 16 are diagrams explaining a Direct Link and a problem occurring when the Direct Link is terminated. FIG. 16-1 is a diagram for explaining configurations before the Direct Link is terminated and after the Direct Link is terminated. FIG. 16-2 is a diagram for explaining bandwidths used before the Direct Link is terminated and after the Direct Link is terminated. In a conventional IEEE802.11 standard, data transfer in a network in which an AP is present (infrastructure mode) is always required to be performed via the AP. However, in IEEE802.11e, a function called the Direct Link is present. The Direct Link allows data transfer between STAs to be performed directly, without passing through the AP. A required bandwidth can be halved when the Direct Link is used, compared to the data transfer via the AP.

In FIG. 16-1, (1′) indicates a communication between a STA 603 and a STA 604 using Direct Link. (3) and (4) indicate communications between a STA 601 and a STA 602 via an AP 600. When the Direct Link is terminated for some reason (such as the STAs separating from each other or a shield being inserted between the STAs), the communication is performed via a communication (1) and a communication (2), i.e., through the AP 600. Therefore, double bandwidth is required for data transfer as compared to the case when the Direct Link is used. Moreover, when another STA reserves a bandwidth for QoS data transfer and the like, as shown in FIG. 16-2, the bandwidth required for the communication (1) and the communication (2) performed via the AP 600 cannot be reserved. The QoS of the data transfer may not be ensured.

Non-Patent Document 1:

http://www.ili-info.com/ieee802drafts/ [symbol] 17 [symbol] 3 [symbol] 31

[symbol]

### DISCLOSURE OF INVENTION

### Problem to be Solved by the Invention

The present invention has been achieved in light of the above-described issues. An object of the present invention is to provide, in a wireless LAN system including first communication mode and second communication mode, a wireless LAN system, and an access point and a station thereof. The first communication mode performs data communication between stations via the access point. The second communication mode performs data communication directly between the stations. The wireless LAN system can ensure QoS of data transfer even when the second communication mode is terminated.

### Means for Solving Problem

To solve the above problems and to achieve the above objects, according to an aspect of the present invention, there is provided a wireless LAN system that includes a plurality of stations and an access point interconnected via a network and supports QoS. The wireless LAN system includes a first communication mode in which data communication is performed between the stations via the access point and a second communication mode in which data communication is performed directly between the stations. The access point performs a process for reserving a bandwidth W2, in response to a QoS bandwidth reservation request in the second mode from a station from among the stations. The bandwidth W2 is a bandwidth equal to or greater than twice a bandwidth W1 required in the second communication mode.

According to another aspect of the present invention, there is provided an access point in a wireless LAN system that includes a plurality of stations and the access point interconnected via a network, supports QoS, and includes a first communication mode in which data communication is performed between the stations via the access point and a second communication mode in which data communication is performed directly between the stations. The access point performs a process for reserving a bandwidth W2 that is equal to or greater than twice a bandwidth W1 required in the second communication mode, in response to a QoS bandwidth reservation request in the second communication mode from a station from among the stations.

According to still another aspect of the present invention, there is provided a station in a wireless LAN system, which includes a plurality of the stations and an access point interconnected via a network, supports QoS, and includes a first communication mode in which data communication is performed between the stations via the access point and a second communication mode in which data communication is performed directly between the stations. The station transmits a QoS bandwidth reservation request to the access point requesting reservation of a bandwidth W2, which is equal to or greater than twice a bandwidth W1 required in the second communication mode, in response to a QoS bandwidth reservation request in the second communication mode from an upper layer.

### BRIEF DESCRIPTION OF DRAWINGS

FIG. 1 is a diagram of an example of a configuration of a wireless LAN system according to a first embodiment.

FIG. 2 is a diagram of an example of a configuration of an AP (access point).

FIG. 3 is a diagram of an example of a configuration of a STA (station).

FIG. 4 is a diagram of a layer structure (network protocol stack) of the wireless LAN system.

FIG. 5 is a diagram of a sequence until QoS bandwidth reservation is performed and polling is started when Direct Link is being used.

FIG. 6 is a flowchart explaining in detail a QoS bandwidth reservation process when the Direct Link is being used.

FIG. 7-1 is a diagram of a configuration of an ADDTS QoS Action Request frame.

FIG. 7-2 is a diagram of a TS Info field format.

FIG. 8-1 is a diagram of a configuration of an ADDTS QoS Action Response frame.

FIG. 8-2 is a diagram of a Schedule Info field format.

FIG. 9 is a diagram for explaining an AP state transition and a bandwidth assignment.

FIG. 10 is a diagram of an example of scheduling performed by the AP.

FIG. 11 is a diagram for explaining the AP state transition and the bandwidth assignment.

FIG. 12 is a diagram of an example of the scheduling performed by the AP.

FIG. 13 is a flowchart for explaining in detail a QoS bandwidth reservation process when the Direct Link is being used (when the station STA performs a first operation and when the access point AP performs a second operation).

FIG. 14 is a flowchart explaining in detail the QoS bandwidth reservation process when the Direct Link is being used (when the station STA performs the second operation and when the access point AP performs the first operation).

FIG. 15-1 is a diagram of a configuration of a wireless LAN system complying with IEEE802.11e.

FIG. 15-2 is a diagram of an example of a QoS data transfer sequence based on IEEE802.11e.

FIG. 16-1 is a diagram for explaining a configuration before and after termination of the Direct Link.

FIG. 16-2 is a diagram for explaining bandwidths used before and after termination of the Direct Link.

### EXPLANATIONS OF LETTERS OR NUMERALS

1 wireless LAN system
AP access point
STA1A to STAnB stations
101 CPU
102 ROM
103 RAM
104 inputting device
105 displaying device
106 external interface
107 bus interface
150 wireless LAN device
151 antenna
152 transmitting and receiving unit
153 data buffer
154 controlling unit
155 scheduling unit
156 storing unit
200 station main body
201 CPU
202 ROM
203 RAM
204 inputting device
205 displaying device
206 bus interface
300 wireless LAN device
301 antenna
302 transmitting and receiving unit
303 data buffer
304 controlling unit
401 application layer
402 presentation layer
403 session layer
404 transport layer
405 network layer
406 MAC layer (data link layer)
407 physical layer

### BEST MODE(S) FOR CARRYING OUT THE INVENTION

Exemplary embodiments of the present invention are below described in detail with reference to the attached drawings. The present invention is not limited by the embodiments. Not all combinations of characteristics described according to the embodiments are required in a solution means of the present invention. Constituent elements according to the embodiments below include those at which a person skilled in the art can easily arrived and those that are essentially same.

### First Embodiment

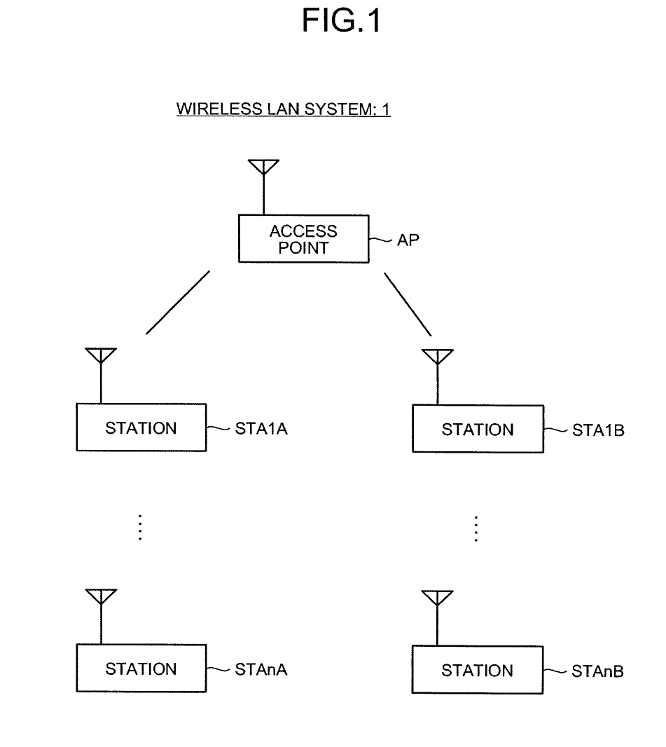

FIG. 1 is a diagram of an example of a system configuration of a wireless LAN system 1 according to a first embodiment. The wireless LAN system 1 shown in FIG. 1 is configured in compliance with IEEE802.11e. As shown in the diagram, the wireless LAN system 1 includes an access point AP and stations STA1A to STAnB. Hereafter, when the stations STA1A to STAnB are not particularly required to be differentiated, the stations STA1A to STAnB are referred to as an “STA”.

In the wireless LAN system 1, the AP takes into consideration a transmission request from the stations STA1A to STAnB and performs scheduling to grant a transmission right to the stations STA1A to STAnB. Based on the scheduling, the AP transmits a packet called QoS CF-Poll to the stations STA1A to STAnB. The QoS CF-Poll indicates that the transmission right is granted. The QoS CF-Poll includes information called Transmission Opportunity (TXOP) LIMIT. The TXOP LIMIT indicates a time period over which the transmission right is granted. The STA to which the QoS CF-Poll is addressed is permitted to transmit data during the TXOP period.

Upon completion of a planned data transmission during the TXOP period, the STA transmits a packet called QoS Null to the AP. The QoS Null can includes information related to an amount of un-transmitted data remaining in a transmission buffer in the STA, or information such as time required for the un-transmitted data to be transmitted. The AP receives the QoS Null from the STA, thereby grasping transmission state of stations STA1A to STAnB. Based on the transmission state, the AP performs the above-described scheduling.

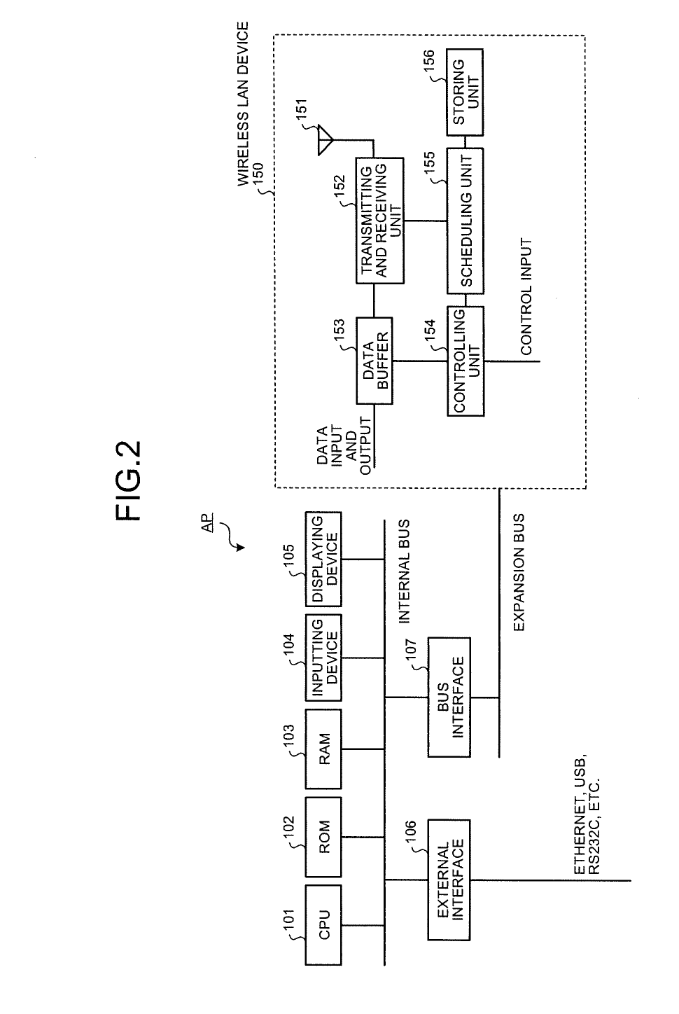

FIG. 2 is a diagram of an example of a hardware configuration of the AP. As shown in FIG. 2, the AP includes a central processing unit (CPU) 101, a read-only memory (ROM) 102, a random-access memory (RAM) 103, an inputting device 104, a displaying device 105, an external interface 106, a bus interface 107, and a wireless LAN device 150. The CPU 101 controls the AP. The ROM 102 stores therein programs that are executed by the CPU 101, data, and the like. The RAM 103 is used as a work area when the CPU 101 executes programs. The inputting device 104 includes a keyboard, a touch panel, a pointing device, and the like. The displaying device 105 includes a liquid crystal display panel, a cathode ray tube (CRT), and the like. The external interface 106 is used to connect with an external device using Ethernet, universal serial bus (USB), RS-232C, and the like. The bus interface 107 is used to connect with the wireless LAN device 150 using an expansion bus.

The wireless LAN device 150 includes an antenna 151, a transmitting and receiving unit 152, a data buffer 153, a controlling unit 154, a scheduling unit 155, and a storing unit 156. The transmitting and receiving unit 152 transmits and receives data. The data buffer 153 temporarily stores therein data. The controlling unit 154 controls operations performed by each unit in the wireless LAN device 150. The storing unit 156 stores therein a QoS data transfer parameter. The scheduling unit 155 performs judgment for accepting and denying a bandwidth reservation request and performs scheduling, based on the QoS data transfer parameter stored in the storing unit 156. The scheduling unit 155 generates a polling timing in accordance to the schedule.

Various settings of the wireless LAN device 150 of the AP are made by the inputting device 104 or the external device connected to the Ethernet, the USB, the RS-232C, and the like via the external interface 106.

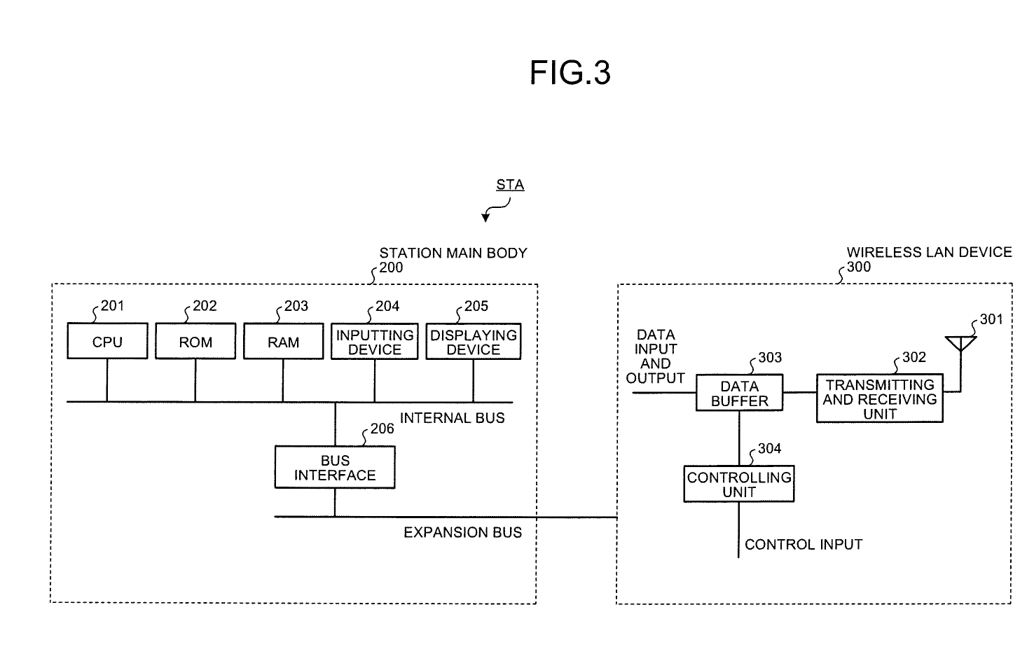

FIG. 3 is a diagram of an example of a hardware configuration of the STA. As shown in FIG. 3, the STA includes a station main body 200 and a wireless LAN device (such as a wireless LAN card) 300. The station main body 200 is a laptop computer or the like. The wireless LAN device 300 is inserted into the station main body 200. Hardware and firmware are installed in the wireless LAN device 300. The hardware and firmware transmit and receive wireless signals and control the wireless signals and the like.

The station main body 200 includes a CPU 201, a ROM 202, a RAM 203, an inputting device 204, a displaying device 205, and a bus interface 206. The CPU 201 controls the STA. The ROM 202 stores therein computer programs that are executed by the CPU 201, data, and the like. The RAM 103 is used as a work area when the CPU 201 it executes the computer programs. The inputting device 104 includes a keyboard, a touch panel, a pointing device, and the like. The displaying device 205 includes a liquid crystal display panel, a CRT, and the like. The bus interface 206 is used to connect with the wireless LAN device 300 using an expansion bus.

The wireless LAN device 300 includes an antenna 301, a transmitting and receiving unit 302, a data buffer 303, and a controlling unit 304. The transmitting and receiving unit 302 transmits and receives data. The data buffer 303 stores the data. The controlling unit 304 controls each unit in the wireless LAN device 300. Various settings of the wireless LAN device 300 of the STA are made by the inputting device 204.

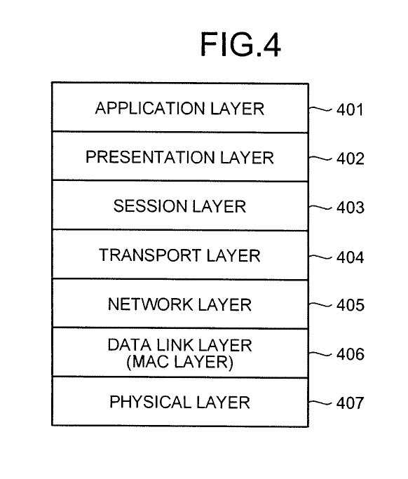

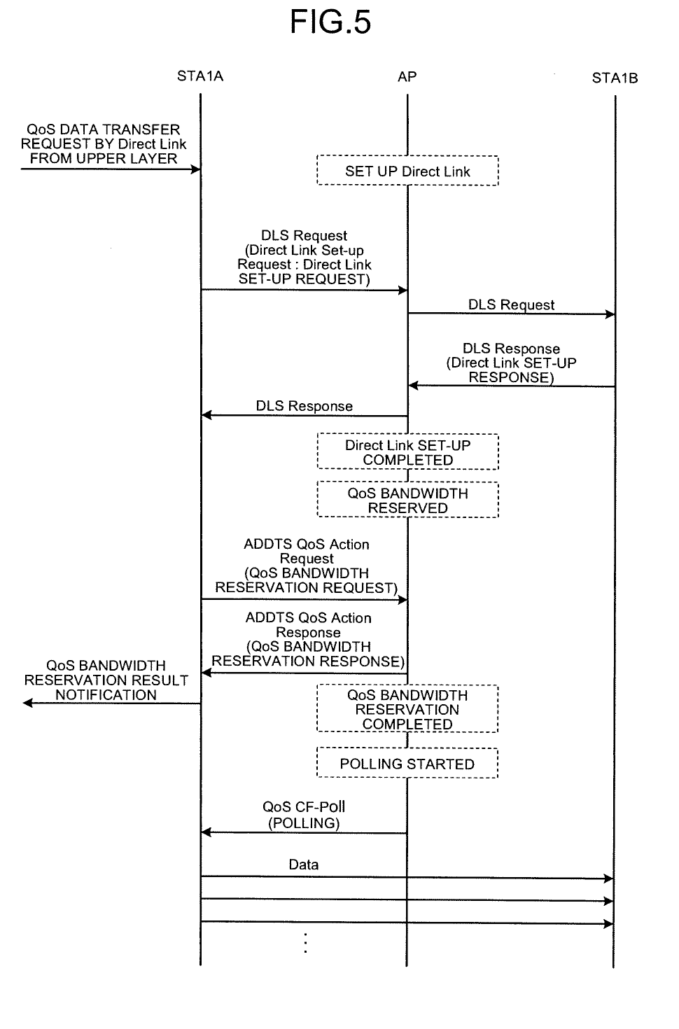

FIG. 4 is a diagram of a layered structure (protocol stack) of the wireless LAN system 1. The protocol stack shown in FIG. 4 complies with an Open Systems Interconnection (OSI) reference model. In the OSI reference model, a network protocol is positioned within a hierarchy of seven logical layers, or in other words, an application layer 401, a presentation layer 402, a session layer 403, a transport layer 404, a network layer 405, a medium access control (MAC) layer (data link layer) 406, and a physical layer 407. A data unit is sent via interfaces between layers. As the data unit is transmitted from a transmission source such as to descend from an upper layer to a lower layer, the data unit is sequentially encapsulated at each layer in accordance with a protocol related to the layer. The data unit is actually transmitted at a lowest layer. At a transmission destination, the data unit is sent such as to ascend the layers. Headers encapsulating the data unit are sequentially removed.

The present invention mainly relates to an operation performed in the MAC layer 406. QoS bandwidth reservation is performed in the MAC layer 406. A request for the QoS bandwidth reservation is issued at the network layer 405 and above, layers 401 to 405. In other words, the request is issued at upper layers 401 to 405.

FIG. 5 is a diagram of a sequence until the QoS bandwidth reservation is performed and polling started when Direct Link is being used. In an explanation hereafter, the STA1A is a transmitting station and the STA1B is a receiving station.

In FIG. 5, when a QoS data transfer request is made by an upper layer using the Direct Link, the STA1A transmits a Direct Link Set-up (DLS) Request to the AP. Upon receiving the DLS Request, the AP transmits the DLS Request to the STA1B. Upon receiving the DLS Request, the STA1B transmits a DLS Response to the AP.

Upon receiving the DLS Response, the AP transmits the DLS Response to the STA1A. The AP then sets up the Direct Link.

Upon receiving the DLS Response, the STA1A transmits an ADDTS QoS Action Request (QoS bandwidth reservation request) to the AP. Upon receiving the ADDTS QoS Action Request, the AP reserves a QoS bandwidth and transmits an ADDTS QoS Action Response (QoS bandwidth reservation response) to the STA1A. Upon receiving the ADDTS QoS Action Response, the STA1A gives a QoS bandwidth reservation result notification to the upper layer.

When the QoS bandwidth reservation is completed, the AP starts polling. The AP transmits the QoS CF-Poll. Data communication using Direct Link is performed between the STA1A and the STA1B.

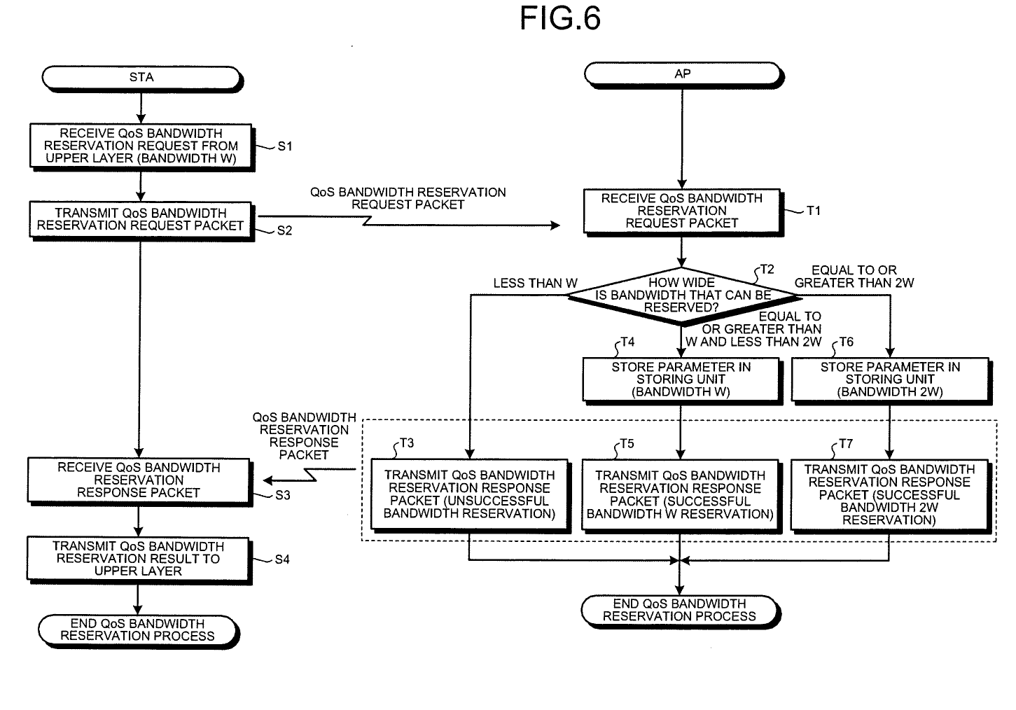

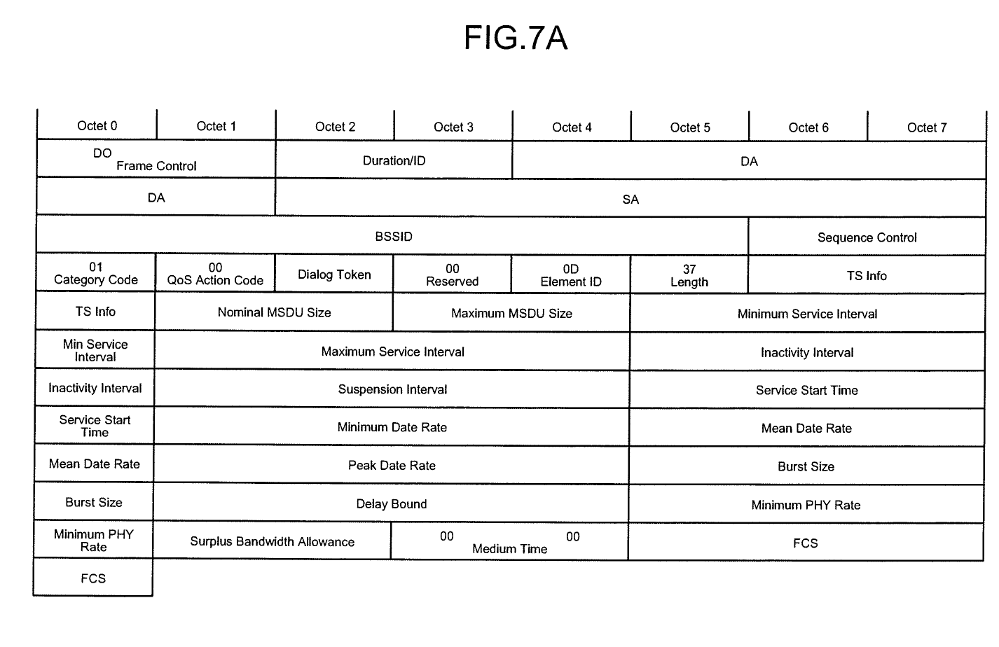

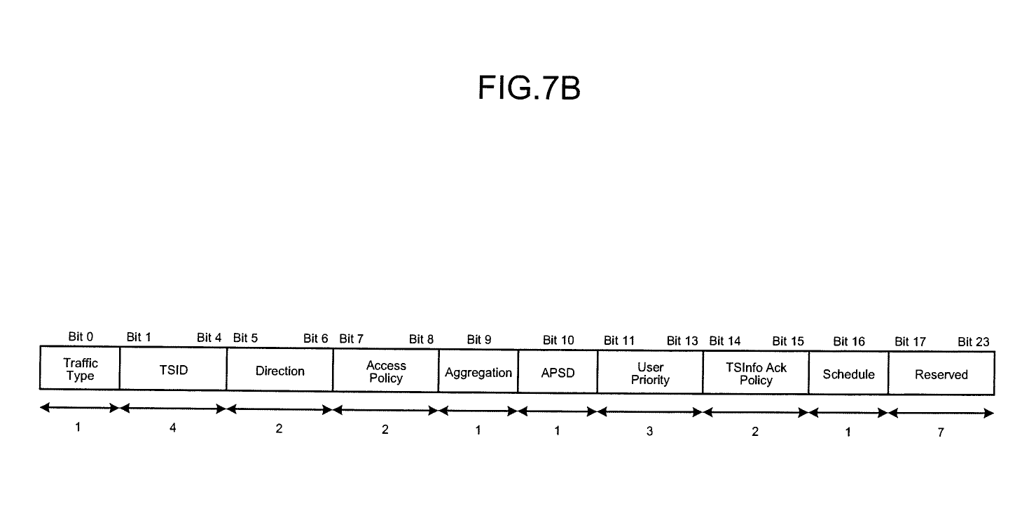

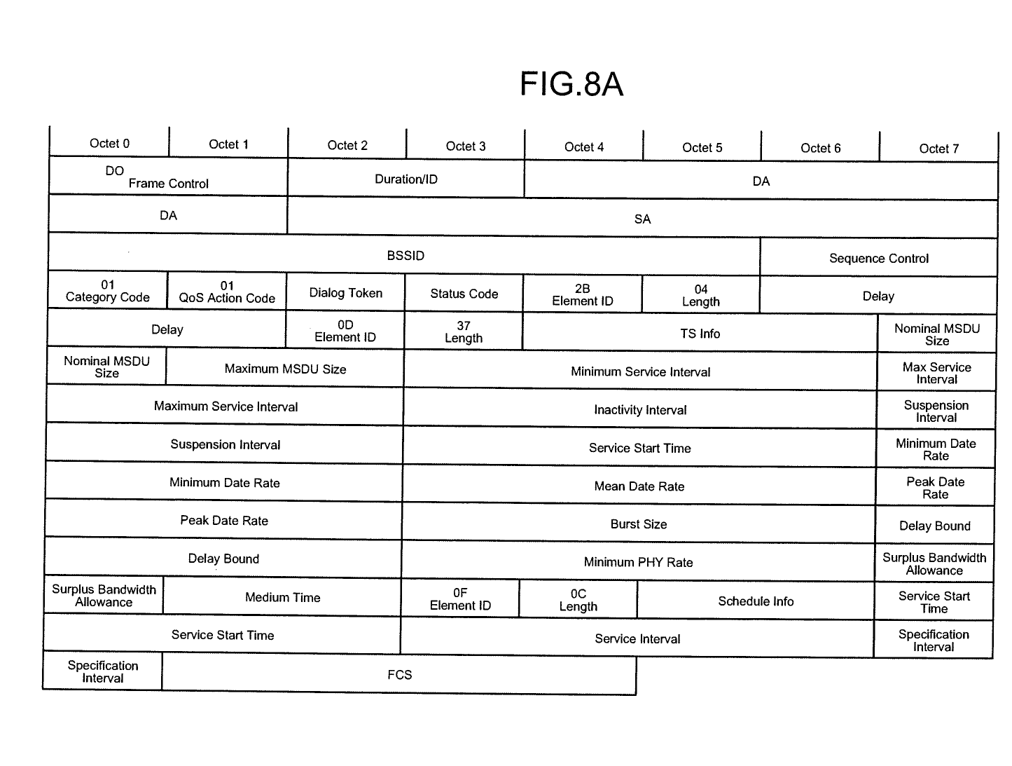

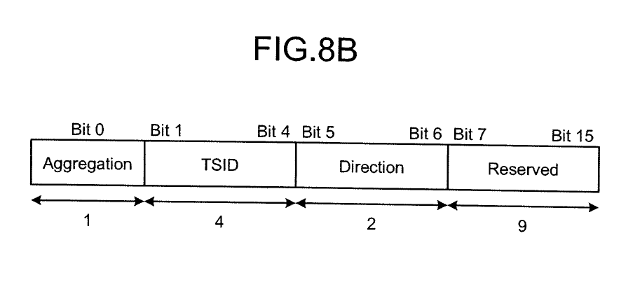

FIG. 6 is a flowchart explaining in detail a QoS bandwidth reservation process when the Direct Link is being used. FIG. 7-1 is a diagram of a configuration of an ADDTS QoS Action Request frame. FIG. 7-2 is a diagram of a format of a TS Info field in FIG. 7-1. FIG. 8-1 is a diagram of a configuration of an ADDTS QoS Action Response frame. FIG. 8-2 is a diagram of a format of a Schedule Info field in FIG. 8-1.

As shown in FIG. 6, the STA receives the QoS bandwidth reservation request for a bandwidth W from the upper layer (Step S1). The STA transmits a QoS bandwidth reservation request packet (ADDTS QoS Action Request frame) to the AP (Step S2). The QoS bandwidth reservation request packet requests the bandwidth W.

The ADDTS QoS Action Request frame is configured as shown in FIG. 7-1. Frame Control indicates a frame type (Type=Management and Subtype=Action). Duration/ID indicates a network allocation vector (NAV) setting value. DA indicates a MAC address of a transmission destination. SA indicates a MAC address of a transmission source. BSSID indicates a basic service set identifier (BSSID) to which a network belongs. Sequence Control indicates a sequence number and a fragment number. Category Code indicates QoS management (01). QoS Action Code indicates ADDTS Request (00). Dialog Token indicates an arbitrary value correlated to a response. Element ID indicates a succeeding traffic specification (TSPEC) Element (OD). Length indicates a length of the TSPEC Element (55octet). Refer to FIG. 7-2 for what TS Info indicates. Nominal MSDU Size indicates a nominal MAC service data unit (MSDU) size. Maximum MSDU Size indicates a maximum MSDU size. Minimum Service Interval indicates a minimum polling interval (microseconds). Maximum Service Interval indicates a maximum polling interval (microseconds). Inactivity Interval indicates a time from when a transmission is stopped to when a reserved bandwidth is deleted (microseconds). Suspension Interval indicates a time from when a transmission is stopped to when polling is stopped (microseconds). Service Start Time indicates a time until polling is started (microseconds). Minimum Data Rate indicates a minimum data rate (bps). Mean Data Rate indicates a mean data rate (bps). Peak Data Rate indicates a maximum data rate (bps). Burst Size indicates a maximum data burst size. Delay Bound indicates a permissible delay time (microseconds). Minimum PHY Rate indicates a minimum PHY rate (bps). Surplus Bandwidth Allowance means the surplus bandwidth required during MSDU transmission. FCS indicates an error detection reference number.

The format of the TS Info field is configured as shown in FIG. 7-2. Traffic Type indicates a traffic pattern (consecutive or intermittent). TSID is used for traffic identification (set by the STA that is the transmission source). Direction indicates a data transfer direction (uplink, downlink, Direct Link, and bidirectional). Access Policy indicates an accessing method (EDCA indicates a presence of an access collision and HCCA indicates no access collision). Aggregation is related to scheduling. APSD is related to power supply control. User Priority indicates an order of priority. TS Info Ack Policy indicates an ACK type. Schedule is related to power supply control.

Upon receiving the QoS bandwidth reservation request packet (ADDTS QoS Action Request frame) from the STA (Step T1), the AP judges a bandwidth that can be reserved (Step T2). When the bandwidth that can be reserved is less than the bandwidth W, the AP transmits a QoS bandwidth reservation response packet (ADDTS QoS Action Response) to the STA stating that the QoS bandwidth reservation is unsuccessful (Step T3). When the bandwidth that can be reserved is equal to or greater than the bandwidth W and less than a bandwidth 2W, the AP stores the QoS data transfer parameter (bandwidth W) in the storing unit 156 (Step T4). The AP transmits the QoS bandwidth reservation response packet (ADDTS QoS Action Response) to the STA stating that the reservation of the bandwidth W is successful (Step T5). When the bandwidth that can be reserved is equal to or more than the bandwidth 2W, the AP stores the QoS data transfer parameter (bandwidth 2W) in the storing unit 156 (Step T6). The AP transmits the QoS bandwidth reservation response packet (ADDTS QoS Action Response) to the STA stating that the reservation of the bandwidth 2W is successful (Step T7).

The ADDTS QoS Action Response frame is configured as shown in FIG. 8-1. Frame Control indicates a frame type (Type=Management, Subtype=Action). Duration/ID indicates a NAV setting value. DA indicates a MAC address of a transmission destination. SA indicates a MAC address of a transmission source. BSSID indicates a BSSID to which a network belongs. Sequence Control indicates a sequence number and a fragment number. Category code indicates QoS management (01). QoS Action Code indicates ADDTS Request (00). Dialog Token indicates a same value as the Dialog Token of a corresponding request. Status Code indicates a QoS bandwidth reservation result. Element ID indicates a succeeding TS Delay (2B). Length indicates a length of the TS Delay (4octet). Delay indicates a time required to be kept open until next QoS bandwidth reservation request (1024-microsecond unit). Element ID indicates a succeeding TSPEC Element (OD). Length indicates a length of the TSPEC Element (55octet). Refer to FIG. 7-2 for what TS Info indicates. Nominal MSDU Size indicates a nominal MSDU size. Maximum MSDU Size indicates a maximum MSDU size. Minimum Service Interval indicates a minimum polling interval (microseconds). Maximum Service Interval indicates a maximum polling interval (microseconds). Inactivity Interval indicates a time from when a transmission is stopped to when a reserved bandwidth is deleted (microseconds). Suspension Interval indicates a time from when a transmission is stopped to when polling is stopped (microseconds). Service Start Time indicates a time until polling is started (microseconds). Minimum Data Rate indicates a minimum data rate (bps). Mean Data Rate indicates a mean data rate (bps). Peak Data Rate indicates a maximum data rate (bps). Burst Size indicates a maximum data burst size. Delay Bound indicates a permissible delay time (microseconds). Minimum PHY Rate indicates a minimum PHY rate (bps). Surplus Bandwidth Allowance means the surplus bandwidth required during MSDU transmission. Medium Time indicates an amount of time during which exclusivity is granted (32-microsecond unit and per second). Element ID indicates a succeeding Schedule Element (OF). Length indicates a length of the Schedule Element (12octet). Refer to FIG. 8-2 for what Schedule Info indicates. Service Start Time indicates time until polling is started (microseconds). Service Interval indicates a polling interval (microseconds). Specification Interval indicates an interval over which correct scheduling is confirmed (1024-microsecond unit). FCS indicates an error detection reference number.

The format of the Schedule Info field is configured as shown in FIG. 8-2. Aggregation is related to scheduling. TSID is used for traffic identification (set by the STA that is the transmission source). Direction indicates a data transfer direction (uplink, downlink, Direct Link, and bidirectional).

Upon receiving the QoS bandwidth reservation response packet (ADDTS QoS Action Response) from the AP (Step S3), the STA notifies the upper layer of the QoS bandwidth reservation result (Step S4).

When the STA uses the Direct Link, the AP reserves the bandwidth 2W that is twice the bandwidth W in response to the QoS bandwidth reservation request from the STA requesting the bandwidth W, as described above. Therefore, even when the Direct Link is terminated, the QoS of the data transfer can be ensured. In other words, when the Direct Link is terminated, the AP intervenes in the communication between the STAs. Upstream communication to the AP and downstream communication from the AP are generated. A half of the bandwidth 2W reserved during the Direct Link set-up is assigned to each communication. As a result, the QoS can be maintained. A process such as this is performed to reserve the bandwidth required after termination in advance, during the Direct Link set-up. Therefore, QoS of data transfer can be performed with certainty.

When the STA uses the Direct Link, the AP can internally reserve the bandwidth 2W that is twice the bandwidth W in response to the QoS bandwidth reservation request from the STA requesting the bandwidth W. During scheduling, the AP can assign the bandwidth W to the STA. In this case, when the Direct Link used by the STA is terminated, the AP can immediately assign the internally reserved 2W of bandwidth. Therefore, the QoS can be maintained even when the Direct Link is terminated.

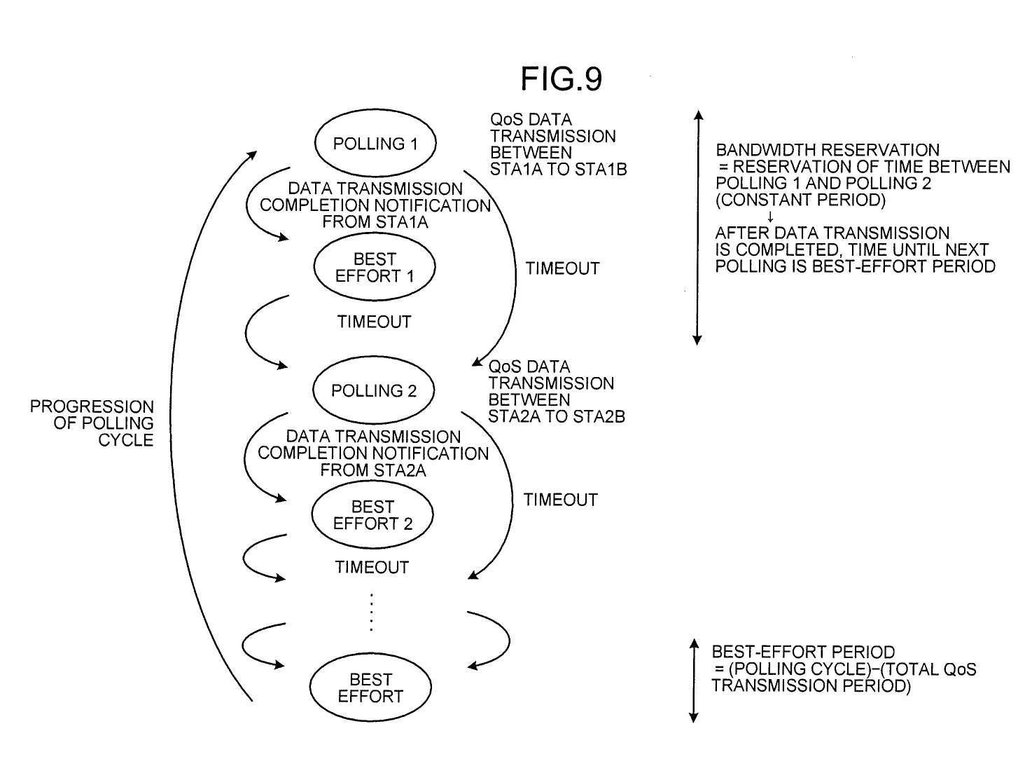

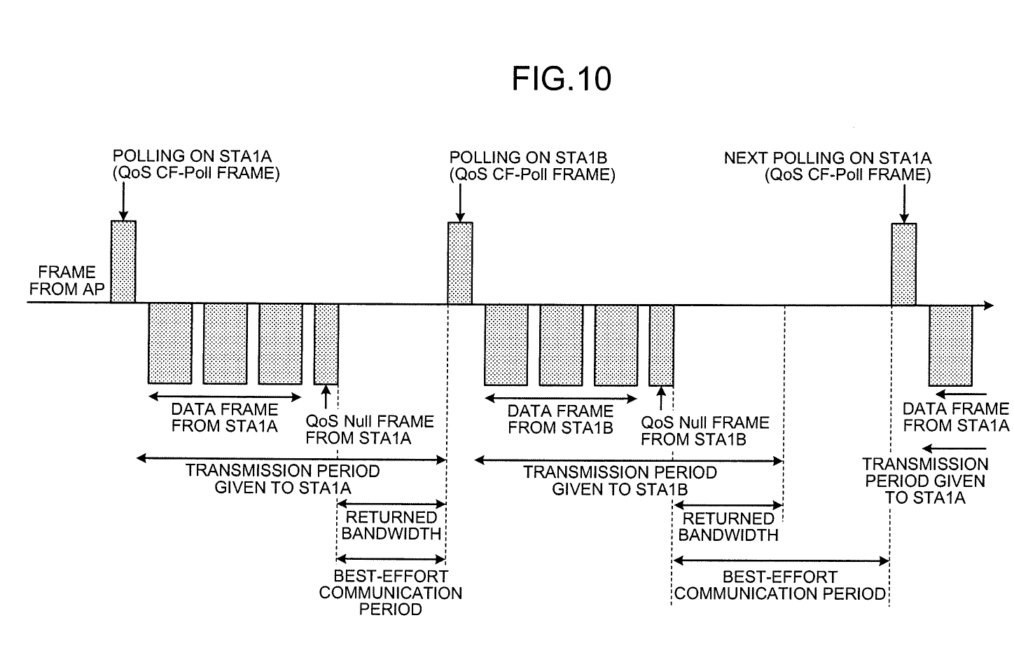

FIG. 9 is a diagram explaining an example of an AP state transition and bandwidth assignment. FIG. 10 is a diagram of an example of the scheduling performed by the AP. In the example shown in FIG. 10, the STA1A and the STA1B transfer the QoS data. In FIG. 9, the AP collects the QoS bandwidth request from each STA1A to STAnA and performs scheduling. Based on the scheduling, the AP transmits a QoS CF-Poll frame to the STA1A and performs polling (polling 1). The QoS CF-Poll frame (polling frame) includes information such as a MAC address of a STA to be polled and a transmission period. When the STA1S that is given a predetermined transmission period runs out of transmission data, the STA1A transmits a QoS Null frame to the AP and returns surplus bandwidth. The surplus bandwidth (time) is used in competitive communication (normal communication) without polling being performed. In terms of communication quality, this is a best-effort communication. Here, a best-effort period equals a polling cycle subtracted by a QoS transmission time. When the transmission period ends, the AP performs polling (polling 2) on a subsequent STA2A.

In this way, even when the bandwidth 2W that is twice the bandwidth W actually required when the Direct Link is used is reserved, the bandwidth W that is half of the bandwidth 2W and is not actually used is used in the best-effort communication.

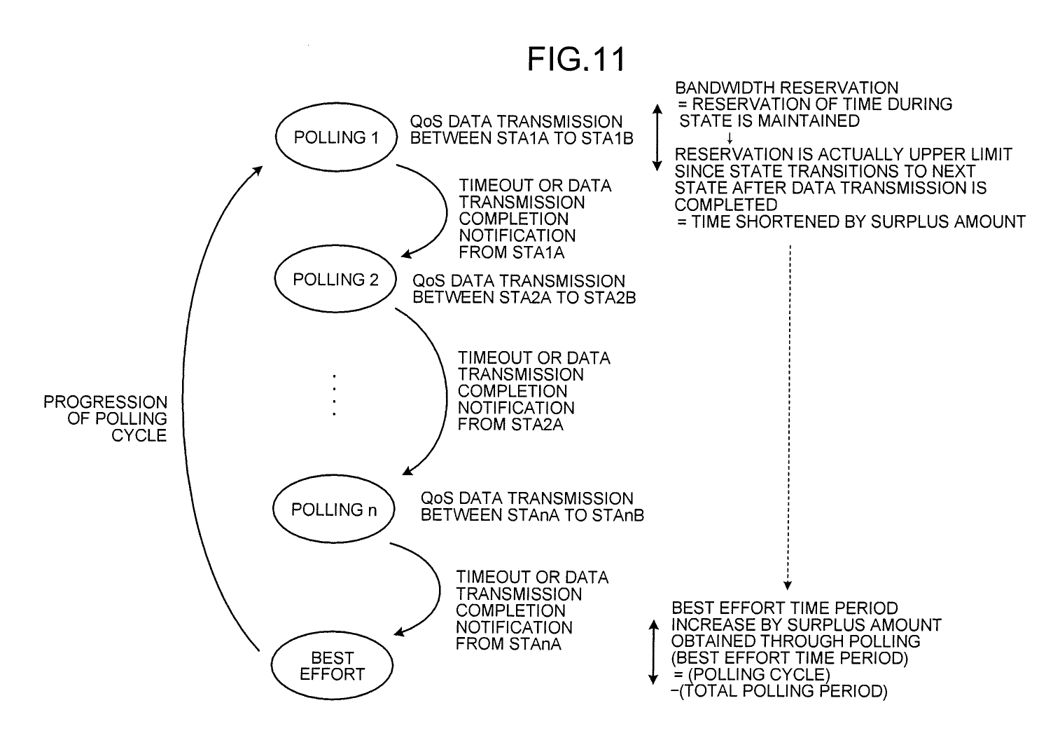

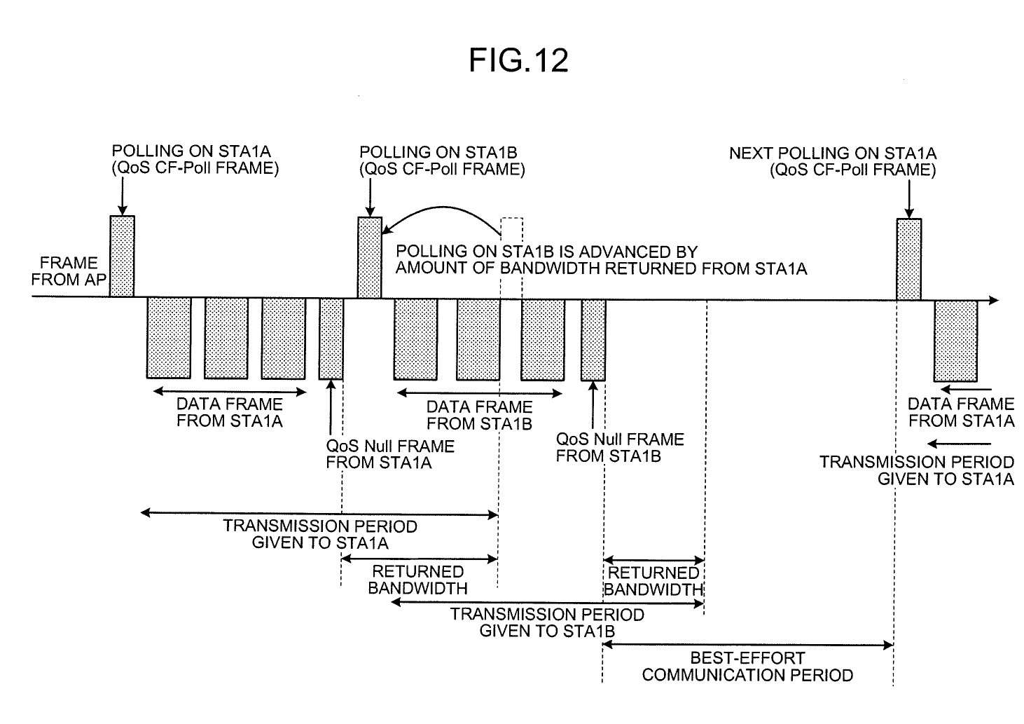

In FIG. 9 and FIG. 10, the bandwidth returned from the STA is used in the best-effort communication. However, when the QoS Null frame is received, the AP can advance polling time and perform the next polling. FIG. 11 is a diagram explaining the AP state transition and the bandwidth assignment (another example). FIG. 12 is an example of the scheduling performed by the AP (another example). In the example shown in FIG. 12, the QoS data transfer is performed by the STA1A and the STA1B.

In FIG. 11, based on the scheduling, the AP transmits the QoS CF-Poll frame to the STA1A and performs polling (polling 1). The STA1A that is given a predetermined transmission period transmits the QoS Null frame to the AP when the STA1A runs out of transmission data. The STA1A returns the surplus bandwidth. Upon receiving the QoS Null frame, the AP advances the polling time and performs polling (polling 2) on the subsequent STA2A. The best-effort communication is performed using the surplus bandwidth (time) obtained by the polling being advanced. Here, the best-effort period equals the polling cycle subtracted by a total polling period.

As described above, in the wireless LAN system according to the first embodiment, the AP reserves the bandwidth 2W that is twice the bandwidth W required when the Direct Link is used, in response the QoS bandwidth reservation request from the station STA using the Direct Link. Therefore, even when the Direct Link is terminated, the QoS of the data transmission can be ensured.

### Second Embodiment

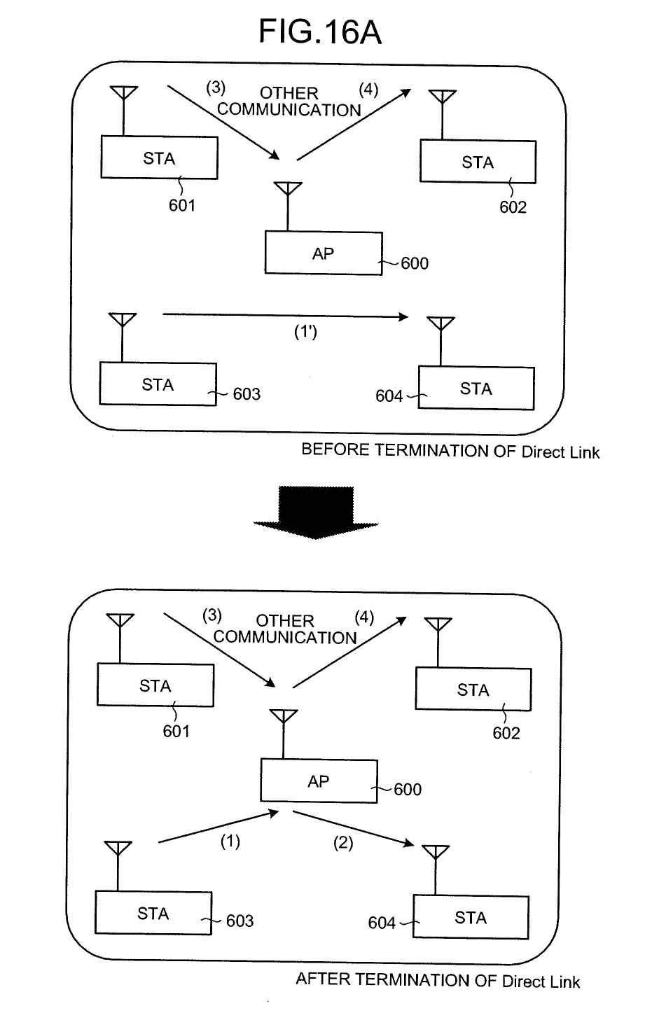

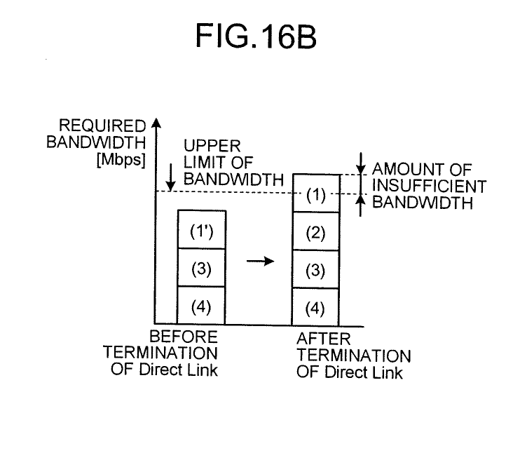

As described above, conventional AP and STA in compliance with IEEE802.11e are configured to reserve the bandwidth W as the QoS bandwidth when the Direct Link is used (see FIG. 16). On the other hand, although the AP and the STA of the present invention are configured in compliance with the IEEE802.11e, the bandwidth 2W that is twice the bandwidth W is reserved when the Direct Link is used. According to a second embodiment, a method of reserving the bandwidth 2W that is twice the bandwidth W as the QoS bandwidth when the Direct Link is used, even when the AP and the STA of the present invention and the conventional AP and STA are present in combination will be described. Hereafter, the conventional AP and STA in compliance with the IEEE802.11e are referred to as an AP and a STA performing a first operation. The AP and the STA of the present invention are referred to as an AP and a STA performing a second operation.

Various methods can be considered for a method of identifying the AP and the STA performing the first operation and the AP and the STA performing the second operation. For example, (1) a method of using identifying information (including a beacon and the like) from the AP, (2) a method of setting the STA in advance (using a setting switch, a control program, and the like), (3) a method in which the STA transmits identifying information when connecting to the AP or during association and the AP stores the identifying information, and (4) a method of including the identifying information in the QoS bandwidth reservation request packet can be considered. Any method can be used in the present invention. The identification method is not limited.

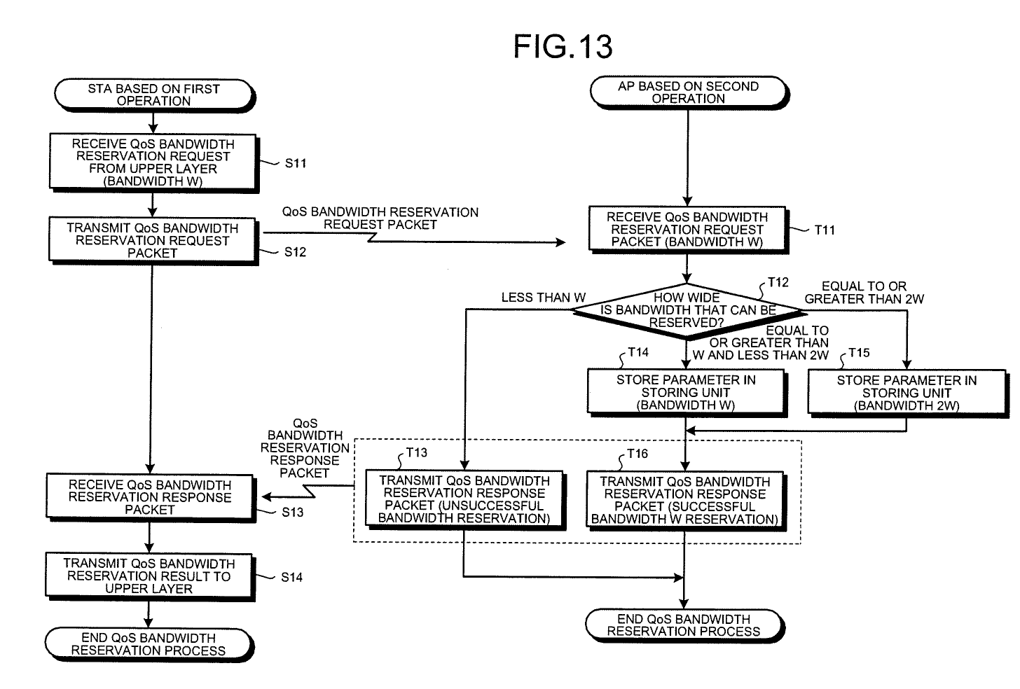

FIG. 13 is a flowchart explaining in detail the QoS bandwidth reservation process when the Direct Link is being used. When the STA performs the first operation, the AP performs the second operation.

In FIG. 13, upon receiving the QoS bandwidth reservation request for the bandwidth W from the upper layer (Step S11), the STA transmits the QoS bandwidth reservation request packet (ADDTS QoS Action Request frame) in which the bandwidth is the bandwidth W to the AP (Step S12).

Upon receiving the QoS bandwidth reservation request packet (ADDTS QoS Action Request frame) from the STA (Step T11), the AP judges the bandwidth that can be reserved (Step T12). When the bandwidth that can be reserved is less than the bandwidth W, the AP transmits the QoS bandwidth reservation response packet (ADDTS QoS Action Response) to the STA stating that the QoS bandwidth reservation is unsuccessful (Step T13). When the bandwidth that can be reserved is equal to or greater than the bandwidth W and less than the bandwidth 2W, the AP stores the QoS data transfer parameter (bandwidth W) in the storing unit 156 (Step T14). The AP transmits the QoS bandwidth reservation response packet (ADDTS QoS Action Response) to the STA stating that the reservation of bandwidth W is successful (Step T16). When the bandwidth that can be reserved is equal to or more than the bandwidth 2W, the AP stores the QoS data transfer parameter (bandwidth 2W) in the storing unit 156 (Step T15). The AP transmits the QoS bandwidth reservation response packet (ADDTS QoS Action Response) to the STA stating that the reservation of bandwidth W is successful (Step T16).

Upon receiving the QoS bandwidth reservation response packet (ADDTS QoS Action Response) from the AP (Step S13), the STA notifies the upper layer of the QoS bandwidth reservation result (Step S14).

As described above, when the STA uses the Direct link, the AP internally reserves the bandwidth 2W that is twice the bandwidth W, in response to the QoS bandwidth reservation request from the STA requesting the bandwidth W. During scheduling, the AP assigns the bandwidth W to the STA. As a result, when the Direct Link used by the STA is terminated, the internally reserved 2W of bandwidth can be immediately assigned. Therefore, the QoS can be maintained even when the Direct Link is terminated.

For example, in a wireless LAN system other than that based on IEEE802.11e in which the STA does not return the surplus bandwidth even when the transmission data has run out during the provided transmission time period, the AP can internally reserve twice the bandwidth of that requested by the STA to perform judgment on whether the bandwidth reservation is possible. During scheduling, the AP can assign the bandwidth as requested by the STA.

As according to the first embodiment, the AP can be configured such as to reserve the bandwidth 2W when the bandwidth 2W can be reserved.

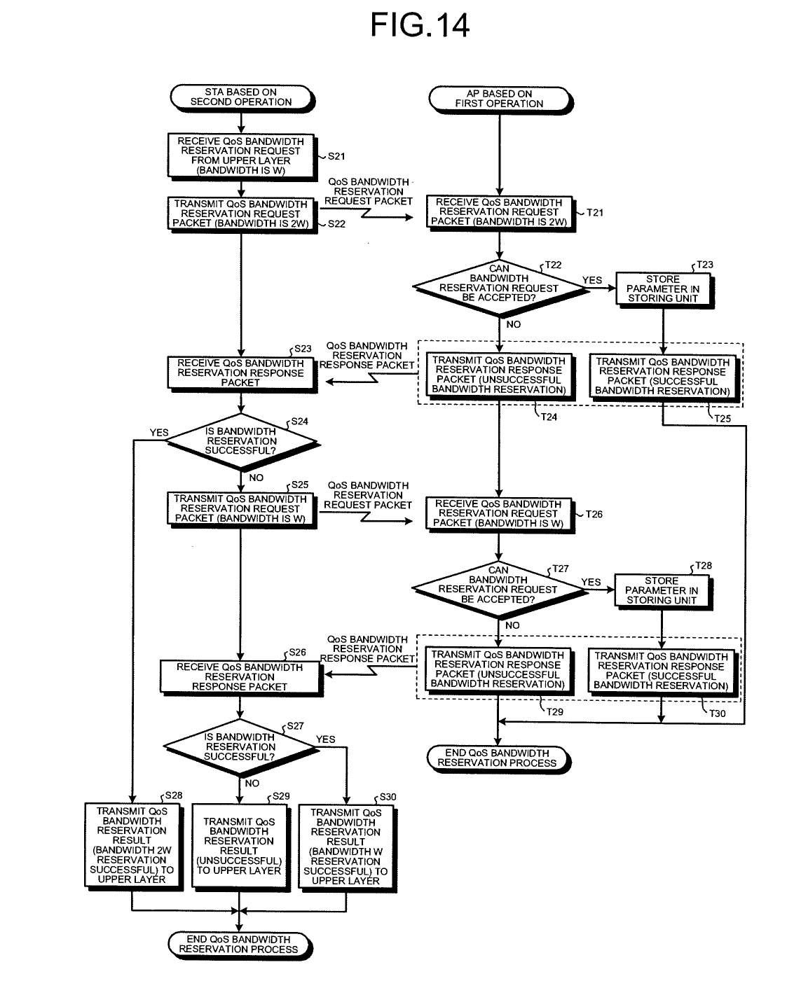

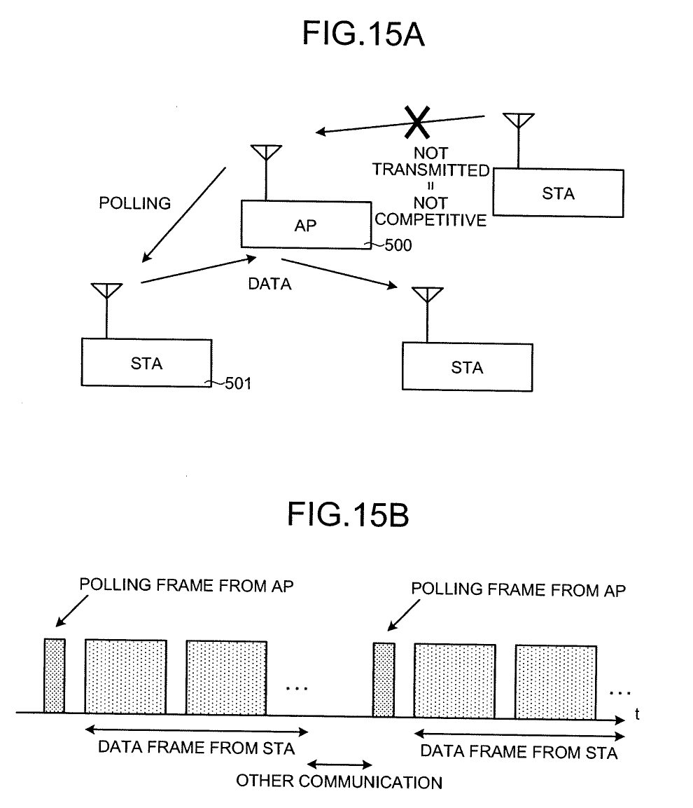

FIG. 14 is a flowchart explaining in detail the QoS bandwidth reservation process when the Direct Link is being used. When the STA performs the second operation, the AP performs the first operation.

In FIG. 14, when upon receiving the QoS bandwidth reservation request for the bandwidth W from the upper layer (Step S21), the STA transmits the QoS bandwidth reservation request packet (ADDTS QoS Action Request frame) for the bandwidth 2W to the AP (Step S22).

Upon receiving the QoS bandwidth reservation request packet (ADDTS QoS Action Request frame) for the bandwidth 2W from the STA (Step T21), the AP judges whether the bandwidth reservation request for the bandwidth 2W from the STA can be accepted (Step T22). When the bandwidth 2W can be reserved, the AP stores the QoS data transfer parameter (bandwidth 2W) in the storing unit 156 (Step T23). The AP transmits the QoS bandwidth reservation response packet (ADDTS QoS Action Response) to the STA stating that the reservation of bandwidth 2W is successful (Step T25). On the other hand, when the bandwidth 2W cannot be reserved, the AP transmits the QoS bandwidth reservation response packet (ADDTS QoS Action Response) stating that the reservation of bandwidth 2W is unsuccessful (Step T24).

Upon receiving the QoS bandwidth reservation response packet (ADDTS QoS Action Response) from the AP (Step S23), the STA judges whether the reservation of the bandwidth 2W is successful (Step S24). When the reservation of the bandwidth 2W is successful, the STA notifies the upper layer of the QoS bandwidth reservation result stating that the reservation of the bandwidth is successful (Step S28). On the other hand, when the reservation of the bandwidth 2W is unsuccessful, the STA transmits the QoS bandwidth reservation request packet (ADDTS QoS Action Request frame) requesting the bandwidth W to the AP (Step S25).

Upon receiving the QoS bandwidth reservation request packet (ADDTS QoS Action Request frame) requesting the bandwidth W from the STA (Step T26), the AP judges whether the bandwidth reservation request for the bandwidth W from the STA can be accepted (Step T27). When the bandwidth W can be reserved, the AP stores the QoS data transfer parameter (bandwidth W) in the storing unit 156 (Step T28). The AP transmits the QoS bandwidth reservation response packet (ADDTS QoS Action Response) to the STA stating that the reservation of bandwidth W is successful (Step T30). On the other hand, when the bandwidth W cannot be reserved, the AP transmits the QoS bandwidth reservation response packet (ADDTS QoS Action Response) stating that the reservation of bandwidth W is unsuccessful (Step T29).

Upon receiving the QoS bandwidth reservation response packet (ADDTS QoS Action Response) from the AP (Step S26), the STA judges whether the reservation of the bandwidth W is successful (Step S27). When the reservation of the bandwidth W is successful, the STA notifies the upper layer of the QoS bandwidth reservation result stating that the reservation of the bandwidth W is successful (Step S30). On the other hand, when the reservation of the bandwidth W is unsuccessful, the STA notifies the upper layer of the QoS bandwidth reservation result stating that the reservation of the bandwidth W is unsuccessful (Step S29).

As described above, according to the second embodiment, the bandwidth 2W that is twice the bandwidth W can be reserved as the QoS bandwidth when the Direct Link is used, even when the AP and the STA of the present invention and the conventional AP and STA are present in combination. The QoS of the data transmission can be ensured even when the Direct Link is terminated.

According to the first embodiment and the second embodiment, when the AP reserves the bandwidth 2W during the Direct Link set-up is described. The bandwidth 2W is twice the bandwidth W required when the Direct Link is used. However, the bandwidth to be reserved is not limited to the bandwidth 2W that is twice the bandwidth W required when the Direct Link is used. As long as a bandwidth W2 that is equal to or greater than a bandwidth W1 required when the Direct Link is used can be reserved, issues of the present invention can be solved.

The wireless LAN system 1 according to the first embodiment and the second embodiment can be applied to various communication network systems. As an example, the wireless LAN system 1 can be favorably used in a network system in which a wireless communication function is installed in a household electrical appliance and the wireless communication function is connected to other wireless communication functions by a household LAN. For example, the AP corresponds to a set-top box used to manage all wireless communication devices within the house. The STA1A corresponds to, for example, a digital versatile disc (DVD) player, a broadcast satellite (BS)/communication satellite (CS) tuner, and the like serving as a moving image reproducing device. The STA1B corresponds to, for example, a television serving as a displaying device. An example can be considered in which the DVD player, the BS/CS tuner, or the like transmits a moving image to the television and the set-top box manages the communication.

### INDUSTRIAL APPLICABILITY

The wireless LAN system, the access point, and the stations of the present invention are suitable for a wireless LAN system that guarantees bandwidth and can be widely used in a system allowing direct data communication between the stations. In particular, the wireless LAN system uses the IEEE802.11e.

1. A wireless LAN system that includes a plurality of stations and an access point interconnected via a network and supports QoS, the wireless LAN system comprising:
a first communication mode in which data communication is performed between the stations via the access point and a second communication mode in which data communication is performed directly between the stations,
wherein the access point performs a process for reserving a bandwidth W2, in response to a QoS bandwidth reservation request in the second mode from a station from among the stations, and
the bandwidth W2 is a bandwidth equal to or greater than twice a bandwidth W1 required in the second communication mode.

2. The wireless LAN system according to claim 1, wherein
the station transmits a QoS bandwidth reservation request to the access point requesting reservation of the bandwidth W2, which is equal to or greater than twice the bandwidth W1 required in the second communication mode, in response to a QoS bandwidth reservation request in the second communication mode from an upper layer, and
the access point performs a process for reserving the bandwidth W2 upon receiving the QoS bandwidth reservation request from the station.

3. The wireless LAN system according to claim 2, wherein
when reservation of the bandwidth W2 is unsuccessful, the access point transmits a QoS bandwidth reservation result to the station stating that the reservation of the bandwidth W2 is unsuccessful,
when the QoS bandwidth reservation result stating that the reservation of the bandwidth W2 is unsuccessful is received, the station re-transmits a QoS bandwidth reservation request to the access point requesting reservation of the bandwidth W1, and
the access point performs a process for reserving the bandwidth W1 upon receiving the QoS bandwidth reservation request from the station.

4. The wireless LAN system according to claim 1, wherein
the station transmits a QoS bandwidth reservation request to the access point requesting reservation of the bandwidth W1, which is required in the second communication mode, upon receiving a QoS bandwidth reservation request in the second communication mode from an upper layer, and
the access point stores the bandwidth W2 in an internal memory and performs a process for reserving the bandwidth W1 upon receiving the QoS bandwidth reservation request from the station.

5. The wireless LAN system according to claim 1, wherein the wireless LAN system complies with IEEE802.11e and the second communication mode is a Direct Link.

6. An access point in a wireless LAN system that includes a plurality of stations and the access point interconnected via a network, supports QoS, and includes a first communication mode in which data communication is performed between the stations via the access point and a second communication mode in which data communication is performed directly between the stations, wherein
the access point performs a process for reserving a bandwidth W2 that is equal to or greater than twice a bandwidth W1 required in the second communication mode, in response to a QoS bandwidth reservation request in the second communication mode from a station from among the stations.

7. The access point in the wireless LAN system according to claim 6, wherein, when reservation of the bandwidth W2 is unsuccessful, the access point performs a process of reserving the bandwidth W1.

8. The access point in the wireless LAN system according to claim 6, wherein the access point stores the bandwidth W2 in an internal memory and performs a process for reserving the bandwidth W1, in response to a QoS bandwidth reservation request from the station requesting the bandwidth W1 in the second communication mode.

9. The access point in the wireless LAN system according to claim 6, wherein the wireless LAN system complies with IEEE802.11e and the second communication mode is a Direct Link.

10. A station in a wireless LAN system, which includes a plurality of the stations and an access point interconnected via a network, supports QoS, and includes a first communication mode in which data communication is performed between the stations via the access point and a second communication mode in which data communication is performed directly between the stations, wherein
the station transmits a QoS bandwidth reservation request to the access point requesting reservation of a bandwidth W2, which is equal to or greater than twice a bandwidth W1 required in the second communication mode, in response to a QoS bandwidth reservation request in the second communication mode from an upper layer.

11. The station in a wireless LAN system according to claim 10, wherein, when a QoS bandwidth reservation result stating that a reservation of the bandwidth W2 is unsuccessful is received from the access point, the station re-transmits a QoS bandwidth reservation request requesting reservation of the bandwidth W1 to the access point.

12. The station in a wireless LAN system according to claim 10, wherein the wireless LAN system complies with IEEE802.11e and the second communication mode is a Direct Link.
